(19) United States
(12) Patent Application Publication
(10) Pub. No.: US 2005/0087181 A1
(43) Pub. Date: Apr. 28, 2005

(54) Method and apparatus of cutting crystalline material

(76) Inventors: Steven Lewis Wille, Palatine, IL (US); Olexy V. Radkevich, Schaumburg, IL (US); Robert S. Zwolinski, Elmhurst, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/953,345

(22) Filed: Sep. 29, 2004

Related U.S. Application Data
(60) Provisional application No. 60/506,836, filed on Sep. 29, 2003.

(51) Int. Cl. B28D 1/08

(52) U.S. Cl. 125/21

(57) ABSTRACT

According to the present invention, a new saw is cutting crystal is provided. This saw uses a driven string wetted with a dissolving fluid so cut crystal material. The present invention avoids the problems of localized heating causing chemical changes in the crystal that occur in other techniques.

### FIELD OF THE INVENTION

The present invention relates to cutting technology, and more specifically the cutting of crystalline materials.

### BACKGROUND

The cutting of crystalline materials is needed in a wide variety of industries. One example is the cutting of quartz crystals for piezoelectric industry. Another is the cutting of Nal crystals for any industry requiring the conversion of gamma rays to photons. Many technologies can be used for the cutting of crystals. Some of the technologies includes using metal blades with or without cutting fluids and/or abrasive materials, wires and strings embedded with or carrying abrasive material, and lasers. These technologies all have a one or more disadvantages. For example, the use of metal blades leads to crystalline properties changes due to localized heating, and also leads to uneven cutting which requires later machining to eliminate the defects. Wires and strings embedded with abrasive material also leads to uneven cutting. Wires and strings carrying abrasive material also leads to crystalline properties changes due to localized heating and uneven cutting which requires later machining to eliminate the defects. Lasers also lead to crystalline properties changes due to localized heating.

There remains a need in the art for a method of cutting crystalline material without altering the properties of the crystal, and yet accurately enough to avoid additional machining steps.

### SUMMARY OF THE INVENTION

According to the present invention, a saw for cutting crystal is provided. The saw has s a fluid retaining string driven by two or more drives. A dissolving fluid is applied to the string. The string then is used to cut crystal. In a preferred embodiment, the crystal is Nal, and the dissolving fluid is water.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a schematic view of the present invention before operation;

FIG. 2 is a schematic view of the present invention in operation.

### DETAILED DESCRIPTION

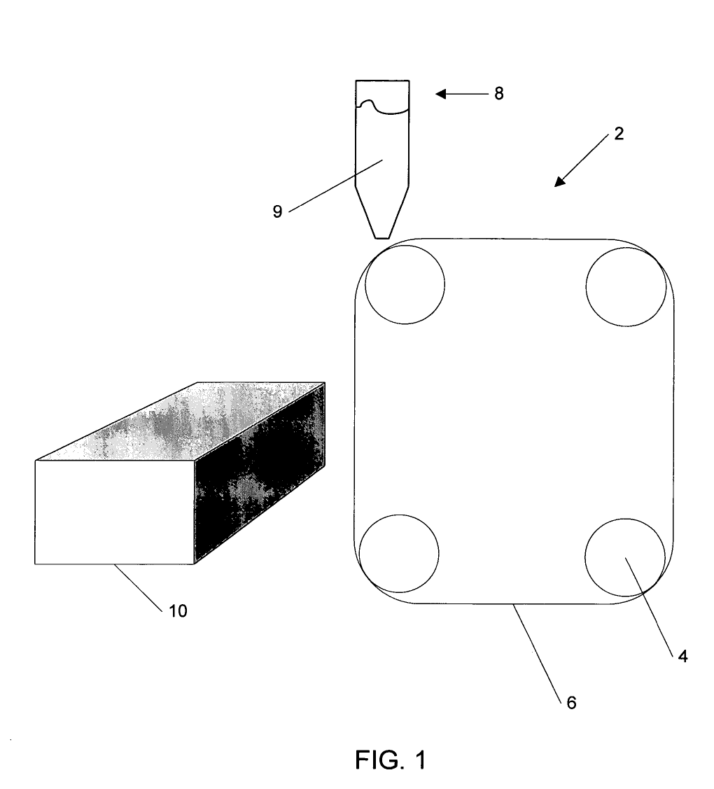

FIG. 1 shows a one embodiment of the present invention. A crystal saw 2 includes a set of drivers 4. A string 6 is mechanically driven the drives. The string 6 is wetted by a source 8 of dissolving fluid 9. The crystal 10 is to be cut by the string 6 moving counterclockwise. The direction of the string is determined by a number of factor, particularly the position of the source of the dissolving fluid 8. In this exemplary embodiment, the source 8 is positioned such that if the string were to be moved clockwise, more of the dissolving fluid would be lost. The dissolving fluid 9 will be applied either continuously is varying amounts throughout the cutting process.

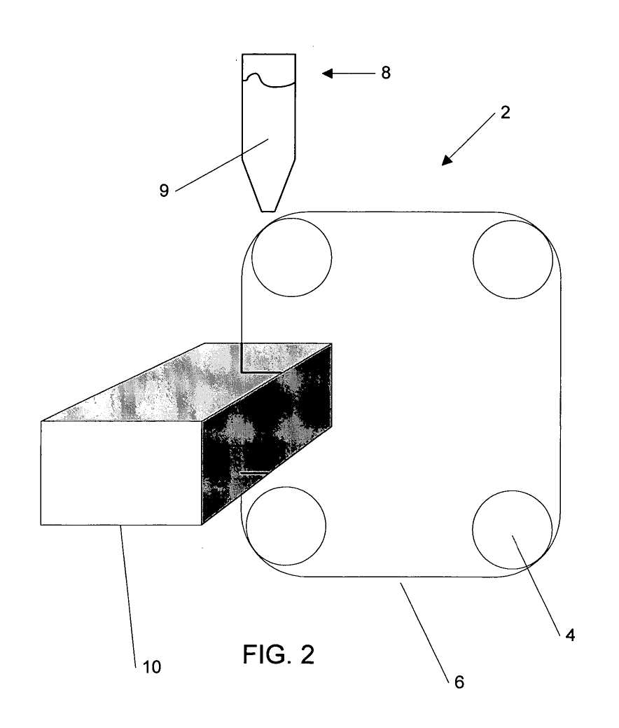

The string 6 may be one of any number of materials including natural fibers, artificial fibers, metal wire, wound metal wire, and plastic extrusions. The requirements include mechanical strength needed to cut the crystal 10, and the ability to transport the dissolving fluid 9. The drivers 4 may be any number of drives, gears, pulleys, cams, bearings or other rotation mechanisms. The dissolving fluid 9 depends upon the nature of the crystal 10. In the preferred embodiment, crystal 10 is Nal or Nal(TI). In such a case, water is the preferred dissolving fluid 9. The water may have any number of additives for improving dissolving the crystal 10, as well as to avoid corrosion in the saw 2. The source 8 may deliver the fluid 9 by gravity-fed, pumped, venturied, or other mechanism. The crystal 10 may be driven to the saw 2, or the saw 2 may be driven to the crystal 10. FIG. 2 shows the cutting action into crystal 10 of saw 2.

While a preferred embodiment of the present invention has been described above, it should be understood that it has been presented by way of example only, and not limitation. Thus, the breadth and scope of the present invention should not be limited by the above described exemplary embodiment. Obviously, numerous modifications and variations of the present invention are possible in light of the above teachings. It is therefore to be understood that the invention may be practiced otherwise than as specifically described herein.

1. A saw comprising:
a) two or more drives;
b) a fluid retaining string in mechanical contact with the drives;
c) a dissolving fluid; and
d) a delivery source for wetting the string with the dissolving fluid;
e) wherein the string is rotated by the drives as the string is wetted by the dissolving fluid.

2. The saw of claim 1, wherein the fluid retaining string is a natural fiber.

3. The saw of claim 1, wherein the fluid retaining string is an artificial fiber

4. The saw of claim 1, wherein the fluid retaining string is a metal wire.

5. The saw of claim 1, wherein the fluid retaining string is a plastic extrusion.

6. The saw of claim 1, wherein the dissolving fluid is water.

7. An apparatus comprising:
a) two or more drives;
b) a fluid retaining string in mechanical contact with the drives;
c) a dissolving fluid; and
d) a delivery source for wetting the string with the dissolving fluid;
e) a crystal,
f) wherein the string cuts the crystal as the string is rotated by the drives and wetted by the dissolving fluid.

8. The apparatus of claim 7, wherein the crystal includes Nal.

9. The apparatus of claim 7, wherein the dissolving fluid includes water.

10. A method of cutting a crystal comprising:
a) rotating a string;
b) wetting a string with a dissolving fluid;
c) cutting the crystal with the string.

11. The method of claim 10, wherein cutting the crystal occurs when the crystal is driven into the string.

12. The method of claim 10, wherein cutting the crystal occurs when the string is driven into the crystal.
